(19) United States
(12) Patent Application Publication
(10) Pub. No.: US 2022/0214532 A1
(43) Pub. Date: Jul. 7, 2022

(54) OPTICAL SYSTEM AND DETECTION METHOD THEROF

(71) Applicant: Apollo Medical Optics, Ltd., Taipei (TW)

(72) Inventors: Tuan-Shu HO, Taipei (TW); Chih-Wei LU, Taipei (TW)

(21) Appl. No.: 17/609,751

(22) PCT Filed: May 8, 2020
(86) PCT No.: PCT/US20/32256

§ 371 Date: Nov. 8, 2021

Related U.S. Application Data
(60) Provisional application No. 62/845,309, filed on May 8, 2019.

(51) Int. Cl. G02B 21/00; G01B 9/02091; G02B 21/02

(52) U.S. Cl. CPC G02B 21/0056; G02B 21/02; G02B 21/0072; G01B 9/02091

(57) ABSTRACT

The present invention provides an optical imaging system having an optical module to project the light onto the sample evenly and effectively. In addition, the present invention provides a method to eliminate image artifacts and improve image quality of an invention optical imaging system disclosed herewith.

### BACKGROUND OF THE INVENTION

An image-forming optical system is a system capable of being used for imaging typically comprising lenses, mirrors, and prisms that constitutes the optical part of an optical instrument. The image-forming optical system, such as optical coherence tomography (OCT), reflectance confocal microscopy (RCM), two-photon luminescence microscopy (TPL), etc., is widely used in various applications such as skin imaging. For example, optical coherence tomography (OCT) is a technique of image interferometry, which has been widely applied on imaging reconstruction of tissue. This interferometric imaging technique allows for high-resolution, cross-sectional imaging of biological samples. For imaging interferometry, broadband illumination will help the axial resolution, and high resolution cross-sectional/volumetric image can be produced.

### SUMMARY OF THE INVENTION

The present invention provides an optical imaging system having an optical module to project the light onto the sample evenly and effectively. In addition, the present invention provides a method to eliminate image artifacts and improve image quality of an invention optical imaging system disclosed herewith.

In one aspect provides an optical system comprising one or more light sources configured to generate one or more beams of light processed into an optical module, the optical module configured to process the beam of light into an objective and direct onto a sample, wherein the beam of light processed into the objective is configured to make the beams of light off axis of center of the objective; and a detector configured to detect a signal back from the sample.

In another aspect provides a method of detecting an optical signal comprising providing one or more beams of light by one or more light sources; processing the beam of light into an objective and directing onto a sample via an optical module, wherein the beam of light processed into the objective is configured to make the beams of light off axis of center of the objective; and detecting a signal back from the sample.

### INCORPORATION BY REFERENCE

All publications, patents and patent applications mentioned in this specification are herein incorporated by reference to the same extent as if each individual publication, patent or patent application was specifically and individually indicated to be incorporated by reference.

### BRIEF DESCRIPTION OF THE DRAWINGS

A better understanding of the features and advantages of the present invention will be obtained by reference to the following detailed description that sets forth illustrative embodiments, in which the principles of the invention are used, and the accompanying drawings of which:

FIG. 1 illustrates an embodiment of the invention optical system.

FIG. 2 illustrates an embodiment of an illumination module of the invention optical system.

FIG. 3 illustrates an embodiment of an illumination module of the invention optical system.

FIG. 4 illustrates an embodiment of an illumination module of the invention optical system.

FIG. 5 illustrates an embodiment of an illumination module of the invention optical system.

FIG. 6 illustrates an embodiment of an illumination module with an adjust means to modify the position of a focal spot in the invention optical system.

FIG. 7 illustrates an embodiment of the invention optical system.

FIG. 8 illustrates an embodiment of invention illumination model comprising a Mirau type objective.

FIG. 9A/B show images resulted from a conventional asymmetric illumination module (9A) in comparison with the one of the invention symmetric illumination module (9B).

FIG. 10 provides exemplary images utilizing invention optical systems.

### DETAILED DESCRIPTION OF THE INVENTION

It is known in the art that the scanning speed and signal to noise ratio of an imaging interferometry system can be improved by concentrating light into a small area via a broadband light source with small etendue. However, a small etendue light source has a drawback of low light utilization in optical system (for example, a Mirau interferometer) with central obscuration resulting an apparent image artifact and decreased image quality. With the etendue conservation, the range of incident angle of full-field illumination is proportional to the etendue of light source. Since the backscattering of a sample is often angular dependent, some information may loss if the range of incident angle is narrow. Besides, imaging artifact along the illumination direction may degrades the image quality. Therefore, there is a need to improve the image quality for such optical image system.

Provided herein is an optical system and a detecting method thereof comprising an optical module with an exemplary illumination model to reduce the image artifact and increase the image quality (such as resolution and image contrast) effectively. Especially, the present invention provides an optical system and a method of detecting an optical signal thereof suitable to an optical system comprising a broadband light source with small etendue.

In order to minimize the image artifact, the illumination light can be a plurality of beams (for example via splitting the illumination light into a plurality of beams), and different illumination beams incidents the sample at different angle. In particular, the illumination fields generated by the beams with different incident angle, in some embodiments, substantially overlap on the sample. Since the intensity distribution of abovementioned illumination fields can be different, the combined illumination field exhibits better illumination uniformity. In some embodiments, the abovementioned beams are generated from different light sources. This illumination strategy can be considered as an almost lossless spatial beam combination method.

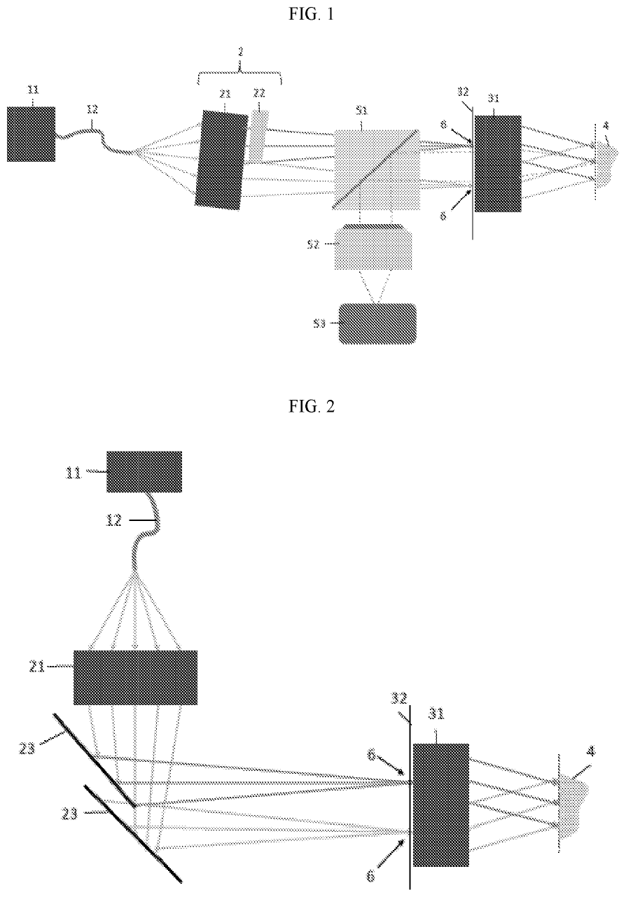

The present invention provides an embodiment as illustrated in FIG. 1. An exemplary optical system comprises an illumination module and an imaging module. The illumination module comprises one or more light sources 11 configured to generate one or more beams of light processed into an optical module 2, where the optical module 2 is configured to process the beam of light into an objective 31 and direct onto a sample 4, wherein the beam of light processing into the objective is configured to make the beams of light off axis of center of the objective. The imaging module of the exemplary optical system comprises a detector 53 configured to detect a signal from the sample 4, in which the light is backscattered from the sample, processed through the beam splitter 51 and a projection lens 52, and finally detected by a detector/camera 53. In some embodiments, the detector is a one-dimensional detector, or a two-dimensional detector, optionally coupled a computer, or combinations thereof. In certain embodiments, the detector is a two-dimensional detector. In certain embodiments, the two-dimensional detector is a charge-coupled device (CCD), a multi-pixel camera, or a complementary metal oxide semiconductor (CMOS) camera, or combination thereof.

In some embodiments, the beams of light processed into the objective is symmetrically illuminated on the sample. In addition, the beams of light processed into the objective is configured to make the illumination field overlapped on the sample, preferably substantially overlapped on the sample. The beams of light processed into the objective is configured to make central rays of the lights substantially parallel. The central ray refers to a central light of a beam light. The definition of “substantially parallel” refers to roughly parallel allowing certain degrees of deviation, such as 0 to 20 degrees deviation, 0 to 15 degrees, 0 to 10 degrees, 0 to 5 degrees, or 0 to 3 degrees deviation. In certain embodiments, the deviation in the term “substantially parallel” is within the allowed experimental error margins.

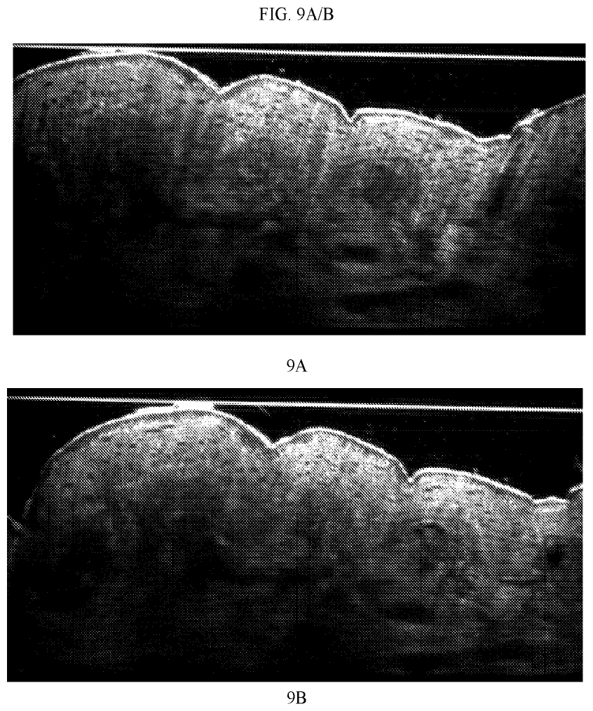

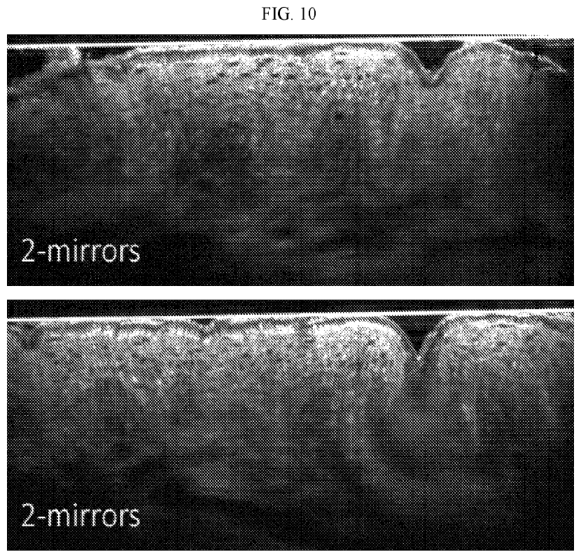

The term, “substantially overlapped” refers to the illumination field overlapped in arrange of 40˜100%, 60˜100%, 80˜100%, or 90˜100% within the allowable error range of known experiments in the field. When the beams of light processed into the objective satisfied the above conditions, the beams of light will bring out off-axis symmetric illumination and evenly illuminated on the sample 4. Due to the symmetric illumination, the image artifact (for example, linear artifact) will be apparently reduced (FIG. 9B) compared with the conventional asymmetric illumination optical system (FIG. 9A). In some embodiments, the resolution and image contrast will also be improved via the present optical system/method.

In some embodiment, in order to achieve symmetric illumination as mentioned above, the optical module can further comprise a light splitting element comprising at least one thick glass, wedge prism, reflective mirror, or combination thereof, so as to split the beam of light into two or more lights. However, it is not limited thereto.

In FIG. 1, a wedge prism 22 is selected as an example of light splitting element. The beam of light pass through the optical fiber 12, then transmit into the optical module 2 comprising an achromatic lens 21 and a wedge prism 22. To split the beam of light from the optical fiber 12, the achromatic lens 21 rotates a specific angle with a wedge prism 22 setting partially on the illumination area output from the achromatic lens 21. The two split lights project onto two focal spots 6 focusing on a focal plane 32 of the objective 31. In certain embodiments, the focal spots 6 do not overlapped each other.

The function of the wedge prism 22 is to provide a deviation angle to a light, such as one of the split lights. The wedge prism 22 has a wedge angle, which has a direct ratio to the focal spots 6 of two split lights. In some embodiments, the wedge angle is in a range of 2° to 10°. In certain embodiments, the wedge angle is in a range of 3° to 9°, 4° to 8°, or 4° to 7°. However, it is not limited thereto. It depends on the desired distance of the focal spots of two split lights.

In some embodiments provide an illumination module of the invention optical system without an imaging module as illustrated in FIG. 2. Compared with FIG. 1, the wedge prism is replaced by two reflective mirrors 23. Each of mirrors 23 reflects partial beam of light from the achromatic lens 21 so as to achieve the light splitting having a feature of substantially parallel central ray and/or overlapped illumination field on the sample, so as to illuminated on the sample symmetrically.

In order to achieve deviation and splitting of the light, in some embodiments, the optical system comprises at least one thick glass disposed between the optical fiber and the optical module to divide the beam of light from the optical fiber into at least two light (figure not shown). This embodiment will also divide beam of light into at least two light and symmetrically illuminated on the sample.

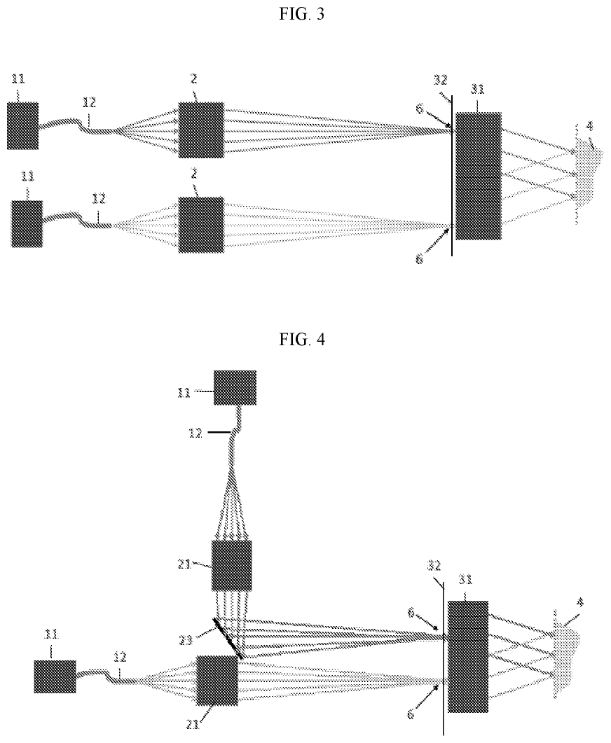

In some embodiments, illumination fields can be directly generated from different light sources or secondary light sources. As illustrated in FIG. 3, which shows an illumination module of an exemplary optical system comprises two light source 11 generating two beams of light into optical modules 2 via optical fibers 12. In further exemplary embodiment, FIG. 4 provides an illumination module with two light sources 11 and a reflective mirror 23 to tilt the optical path achieving the same effect as shown in FIG. 3, or other embodiments.

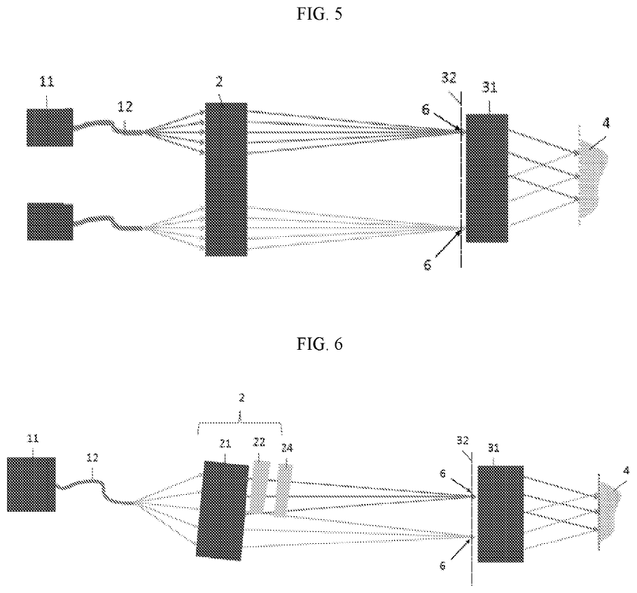

In some embodiments provide an illumination module as illustrated comprising two light sources and an optical module. As illustrated in FIG. 5, an exemplary illumination module comprises two light sources 11 illuminating two beams of light into an optical module 2. Thus, as illustrated above from FIG. 3 to FIG. 5, the method of splitting of the light is achieved through various arrangements from two light sources. A skilled person the art would readily recognize other suitable arrangement/method in accordance with the practice of the present invention.

For some embodiments, in order to further increase the freedom of angular deviation of the beams of light processed into the objective, an illumination module further comprises at least one adjust means 24 to adjust the distance of the at least two focal spots 6 on the focal plane 32 of the objective 31 as illustrated in FIG. 6. In certain embodiments, the adjust means 24 is disposed next to the light splitting element. In certain embodiments, the adjust means 24 comprises at least one wedge. However, the element and the arrangement thereof are not limited thereto. Any optical components with angle change function can be readily recognized as an adjust means.

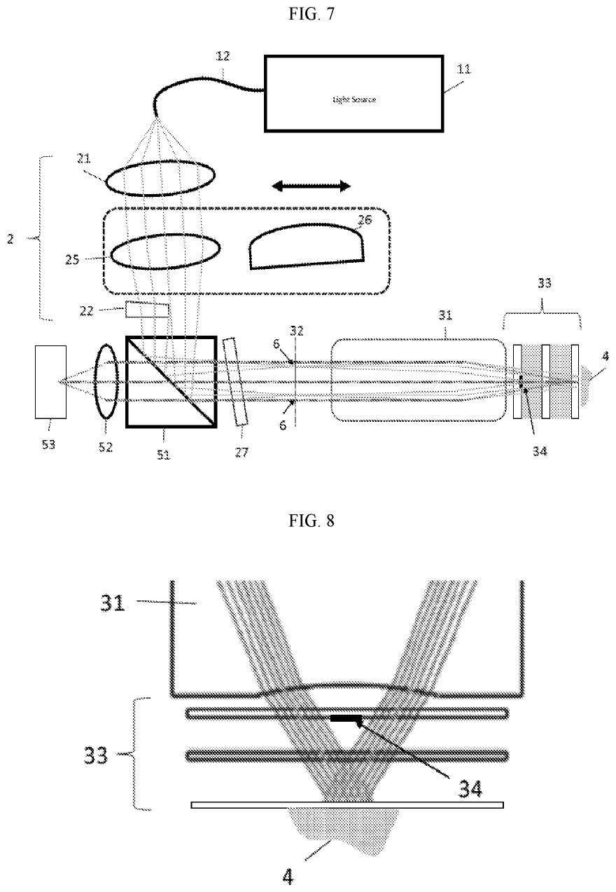

FIG. 7 provides yet another embodiment of the invention optical system, comprising a light source 11 generating a beam of light processed into an optical module 2; the optical module 2 is configured to process the beam of light into an objective 31 and direct onto the sample 4, wherein the beam of light processed into the objective 31 is configured to make the beams of light off axis of center of the objective 31. The light backscattered from the sample 4 will be processed through the beam splitter 51 and projected onto a detector 53 by a projection lens 52. The optical module comprises an achromatic lens 21 to accept the light from the light source 11 via optical fiber 12; a spherical lens 25 is configured to process the light from the achromatic lens 21 and to provide area field light illuminated on the sample. Alternatively, a cylindrical lens 26 can be switched to provide line field light illuminated on the sample; a wedge prism 22 is configured to split light into two lights; and a quarter wave plate 27 is configured to alter the light's polarization. Owing to the switchable of the spherical lens 25 and the cylindrical lens 26, the optical system can be a full field optical system, a line field system, or combinations thereof.

Comparing to other interferometric setup, the Mirau-type interferometer uses a smaller number of optical elements and occupy less space and is less sensitive to environment vibration. One main drawback of Mirau interferometry is the central obscuration by the reference mirror. For in vivo application, to maximize the collection efficiency and signal to noise ratio, the reference mirror is usually highly reflective. This central obscuration may block most of the illumination light in case the etendue of the light source is small.

In some embodiments, a Mirau type objective (interferometer) is included in the invention optical system as illustrated in FIG. 7, which comprises the objective 31 and an interference means 33 with a selective coating 34 reflecting a reference arm to interfere with a sample arm backscattered from the sample 4. The two spilt light processed into the objective 31 to the sample 4 can be unblock by the selective coating 34 by adjusting the distance of the two focal spots 6. In some embodiments, the optical system comprises a Mirau type objective, a Michelson type objective, or a Mach Zender type objective.

In some embodiments, the invention optical system is an optical coherence tomography (OCT) system, a reflectance confocal microscopy (RCM) system, a two-photon luminescence microscopy (TPL) system, or combinations thereof. In certain embodiments, the optical system comprises a Mirau type interferometer, a Michelson type interferometer, or a Mach Zender type interferometer, but it is not limited thereto. Preferably, the optical system comprises a Mirau type interferometer.

In some embodiments, the light source is a low-etendue broadband light source. In certain embodiments, the light source is an amplified spontaneous emission light source, a super luminescent diode (SLD), a light emitting diode (LED), a broadband supercontinuum light source, a mode-locked laser, a tunable laser, a Fourier-domain Mode-locking light source, an optical parametric oscillator (OPO), a halogen lamp, a crystal fiber fluorescence, or combinations thereof, or the like. In certain embodiments, the crystal fiber fluorescence comprises a Ce3+:YAG crystal fiber, a Ti3+:Al2O3 crystal fiber, a Cr4+:YAG crystal fiber, or combinations thereof, however it is not limited thereto.

As illustrated in FIG. 8 providing the Mirau type objective in FIG. 7, the off axis symmetrical lights illuminating on the sample 4 through the objective 31 are preferably unblocked by the selective coating 34 disposed on the interference means 33. Such design improves the efficient use of light allowing fully illuminating light to sample, that improves the signal to noise ratio of the resulted image, thereby improving the image quality.

The present invention provides another exemplary detecting method of an optical system, such as the above-mentioned optical system. The method comprises providing at least a beam of light by at least one light source; processing the beam of light into an objective and directing onto a sample via an optical module, wherein the beam of light processed into the objective is configured to make the beams of light off axis of center of the objective; and detecting a signal back from the sample.

The present optical system/method provides an illumination module/method to split the beam of light into at least two lights and project on a sample, wherein the two off axis and symmetrical beams of light have substantially parallel central ray and/or overlapped illumination field. Based on a preferable symmetric illumination module (or off axis symmetric illumination module) of the present optical system, the image artifacts will be reduced, and the image quality will be effectively improved. The reason is that the illumination provided by the asymmetric illumination module to the sample is a specific or single direction illumination, whereas the illumination provided by the symmetric illumination module to the sample is multi-directional illumination, allowing reduction of the produced image artifacts subsequently improving the resolution and image contrast. FIG. 9A illustrates an image resulted from a conventional asymmetric illumination module in comparison with the image of the invention symmetric illumination module shown in FIG. 9B. Also, FIG. 10 provides exemplary optical images of the invention optical system having two reflective mirrors as in FIG. 2. Through the optical images shown in FIG. 9 and FIG. 10, the exemplary invention optical systems effectively reduce the image artifacts and the linear pattern of optical images. In addition, image quality and signal to noise ratio are also apparently improved comparing with the conventional optical system with asymmetric illumination module.

In some embodiments provide an optical system comprising one or more light sources configured to generate one or more beams of light processed into an optical module, the optical module is configured to process the beam of light into an objective and directed onto a sample, wherein the beams of light processed into the objective is configured to make the beams of light off axis of center of the objective; and a detector configured to detect a signal back from the sample. In certain embodiments, the beams of light processed into the objective is symmetrically illuminated on the sample. In certain embodiments, the beams of light processed into the objective is configured to make the illumination field overlapped on the sample. In certain embodiments, the beams of light processed into the objective is configured to make central rays of the lights substantially parallel. In some embodiments, the optical system comprises at least two light sources. In certain embodiments, the optical module comprises a light splitting element, which comprises at least one thick glass, wedge prism, reflective mirror, or combinations thereof. In certain embodiments, the optical system comprises an optical fiber assembled to transmit the beam of light into the optical module, wherein the thick glass is configured to split the beam of light output from the optical fiber into at least two split lights. In certain embodiments, the optical module comprises an achromatic lens configured to transmit the beam of light from the light source, wherein at least one of wedge prism, reflective mirror, or combinations thereof is disposed to split the beam of light transmitted from the achromatic lens into at least two split lights. In certain embodiments, a wedge angle of the wedge prism is proportional to the distance of the focal spots of the at least two split lights. In certain embodiments, the wedge angle is in a range of 2° to 10° or 4° to 7°. In some embodiments, the optical module comprises an adjust means configured to adjust the distance of focal spots of the beams of light processed into the objective.

In some embodiments, the light source is a small etendue light source comprising an amplified spontaneous emission light source, a super luminescent diode (SLD), a light emitting diode (LED), a broadband supercontinuum light source, a mode-locked laser, a tunable laser, a Fourier-domain Mode-locking light source, an optical parametric oscillator (OPO), a halogen lamp, a crystal fiber fluorescence, or combinations thereof. In certain embodiments, the crystal fiber fluorescence comprises a Ce3+:YAG crystal fiber, a Ti3+:Al2O3 crystal fiber, a Cr4+:YAG crystal fiber, or combinations thereof. In certain embodiments, the optical system is an optical coherence tomography (OCT) system, a reflectance confocal microscopy (RCM) system, a two-photon luminescence microscopy (TPL) system, or combinations thereof. In some embodiments, the optical system is a full field optical system, a line field system, or combinations thereof. In some embodiments, the optical system comprises a Mirau type interferometer, a Michelson type interferometer, or a Mach Zender type interferometer. In certain embodiments, the optical system comprises a Mirau type interferometer comprising an interference means with a selective coating configured to reflects a reference arm interfering with a sample arm backscattered from the sample, and at least two split lights processed into the objective onto the sample wherein the lights off axis of center of the objective illuminating on the sample through the objective are unblocked by the selective coating disposed on the interference means. In certain embodiments, a wedge angle of the wedge prism is proportional to the distance of the focal spots of the at least two split lights. In certain embodiments, the wedge angle is in a range of 2° to 10° or 4° to 7°. In some embodiments, the optical module comprises an adjust means configured to adjust the distance of focal spots of the beams of light processed into the objective. In some embodiments, the light source is a small etendue light source comprising an amplified spontaneous emission light source, a super luminescent diode (SLD), a light emitting diode (LED), a broadband supercontinuum light source, a mode-locked laser, a tunable laser, a Fourier-domain Mode-locking light source, an optical parametric oscillator (OPO), a halogen lamp, a crystal fiber fluorescence, or combinations thereof. In certain embodiments, the crystal fiber fluorescence comprises a Ce3+:YAG crystal fiber, a Ti3+:Al2O3 crystal fiber, a Cr4+:YAG crystal fiber, or combinations thereof. In certain embodiments, the optical system is an optical coherence tomography (OCT) system, a reflectance confocal microscopy (RCM) system, a two-photon luminescence microscopy (TPL) system, or combinations thereof. In some embodiments, the optical system is a full field optical system, a line field system, or combinations thereof. In some embodiments, the optical system comprises a Mirau type interferometer, a Michelson type interferometer, or a Mach Zender type interferometer. In certain embodiments the optical system comprises a Mirau type interferometer comprising an interference means with a selective coating reflecting a reference arm to interfere with a sample arm backscattered from the sample, and at least two split lights processed into the objective onto the sample wherein the lights off axis of center of the objective illuminating on the sample through the objective are unblocked by the selective coating disposed on the interference means.

In some embodiments provide a method of detecting an optical signal comprising providing one or more beams of light by one or more light sources; processing the beams of light into an objective and directing onto a sample via an optical module, wherein the beams of light processed into the objective is configured to make the beams of light off axis of canter of the objective; and detecting a signal back from the sample. In certain embodiments, the beams of light processed into the objective is symmetrically illuminated onto the sample. In certain embodiments, the beams of light processed into the objective is configured to make the illumination field overlapped on the sample. In certain embodiments, the beams of light processed into the objective is configured to make central rays of the lights substantially parallel. In some embodiments, the optical system comprises at least two light sources. In some embodiments, the optical module comprises a light splitting element, which comprises at least one thick glass, wedge prism, reflective mirror, or combinations thereof. In certain embodiments, an optical fiber is assembled to transmit the beam of light into the optical module, wherein the thick glass is configured to split the beam of light output from the optical fiber into at least two split lights.

Although preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein can be employed in practicing the invention. It is intended that the following claims define the scope of the invention and that methods and structures within the scope of these claims and their equivalents be covered thereby.

1. An optical system comprising
one or more light sources configured to generate one or more beams of light processed into an optical module, the optical module is configured to process the beam of light into an objective and directed onto a sample, wherein the beams of light processed into the objective is configured to make the beams of light off axis of center of the objective; and
a detector configured to detect a signal back from the sample.

2. The optical system of claim 1, wherein the beams of light processed into the objective is symmetrically illuminated on the sample; or configured to make the illumination field overlapped on the sample; or configured to make central rays of the lights substantially parallel.

3. (canceled)

4. (canceled)

5. The optical system of claim 1, wherein the optical system comprises at least two light sources; or the optical module comprises a light splitting element, which comprises at least one thick glass, wedge prism, reflective mirror, or combinations thereof.

6. (canceled)

7. The optical system of claim 5, wherein the optical system comprises an optical fiber assembled to transmit the beam of light into the optical module, wherein the thick glass is configured to split the beam of light output from the optical fiber into at least two split lights.

8. The optical system of claim 5, wherein the optical module comprises an achromatic lens configured to transmit the beam of light from the light source, wherein at least one of wedge prism, reflective mirror, or combinations thereof is disposed to split the beam of light transmitted from the achromatic lens into at least two split lights.

9. The optical system of claim 5, wherein a wedge angle of the wedge prism is proportional to the distance of the focal spots of the at least two split lights.

10. The optical system of claim 9, wherein the wedge angle is in a range of 2° to 10° or 4° to 7°.

11. The optical system of claim 1, wherein the optical module comprises an adjust means configured to adjust the distance of focal spots of the beams of light processed into the objective.

12. The optical system of claim 1, wherein the light source is a small etendue light source comprising an amplified spontaneous emission light source, a super luminescent diode (SLD), a light emitting diode (LED), a broadband supercontinuum light source, a mode-locked laser, a tunable laser, a Fourier-domain Mode-locking light source, an optical parametric oscillator (OPO), a halogen lamp, a crystal fiber fluorescence, or combinations thereof.

13. The optical system of claim 12, wherein the crystal fiber fluorescence comprises a Ce3+:YAG crystal fiber, a Ti3+:Al2O3 crystal fiber, a Cr4+:YAG crystal fiber, or combinations thereof.

14. The optical system of claim 1, wherein the optical system is (a) an optical coherence tomography (OCT) system, a reflectance confocal microscopy (RCM) system, a two-photon luminescence microscopy (TPL) system, or combinations thereof; or (b) a full field optical system, a line field system, or combinations thereof.

15. (canceled)

16. The optical system of claim 1, wherein the optical system comprises a Mirau type interferometer, a Michelson type interferometer, or a Mach Zender type interferometer.

17. The optical system of claim 1, wherein the optical system comprises a Mirau type interferometer comprising an interference means with a selective coating configured to reflects a reference arm interfering with a sample arm backscattered from the sample, and at least two split lights processed into the objective onto the sample wherein the lights off axis of center of the objective illuminating on the sample through the objective are unblocked by the selective coating disposed on the interference means.

18. A method of detecting an optical signal comprising
providing one or more beams of light by one or more light sources in an optical system; processing the beams of light into an objective and directing onto a sample via an optical module, wherein the beams of light processed into the objective is configured to make the beams of light off axis of center of the objective; and
detecting a signal back from the sample.

19. The method of claim 18, wherein the beams of light processed into the objective is symmetrically illuminated onto the sample; or configured to make the illumination field overlapped on the sample; or configured to make central rays of the lights substantially parallel.

20. (canceled)

21. (canceled)

22. The method of claim 18, wherein the optical system comprises at least two light sources; or the optical module comprises a light splitting element, which comprises at least one thick glass, wedge prism, reflective mirror, or combinations thereof.

23. (canceled)

24. The method of claim 22, wherein an optical fiber is assembled to transmit the beam of light into the optical module, wherein the thick glass is configured to split the beam of light output from the optical fiber into at least two split lights.

25. The method of claim 22, wherein an achromatic lens is configured to transmit the beam of light from the light source, wherein at least one of wedge prism, reflective mirror, or combinations thereof is disposed to split the beam of light transmitted from the achromatic lens into at least two split lights.

26. The method of claim 22, wherein a wedge angle of the wedge prism is proportional to the distance of the focal spots of the at least two split lights.

27. The method of claim 26, wherein the wedge angle is in a range of 2° to 10° or 4° to 7°.

28. The method of claim 18, comprising adjusting the distance of focal spots of the beams of light processed into the objective via an adjust means.

29. The method of claim 18, wherein the light source is a small etendue light source comprising an amplified spontaneous emission light source, a super luminescent diode (SLD), a light emitting diode (LED), a broadband supercontinuum light source, a mode-locked laser, a tunable laser, a Fourier-domain Mode-locking light source, an optical parametric oscillator (OPO), a halogen lamp, a crystal fiber fluorescence, or combinations thereof.

30. The method of claim 29, wherein the crystal fiber fluorescence comprises a Ce3+:YAG crystal fiber, a Ti3+:Al2O3 crystal fiber, a Cr4+:YAG crystal fiber, or combinations thereof.

31. The method of claim 18, wherein optical system is (a) an optical coherence tomography (OCT) system, a reflectance confocal microscopy (RCM) system, a two-photon luminescence microscopy (TPL) system, or combinations thereof; or (b) a full field optical system, a line field system, or combinations thereof.

32. (canceled)

33. The method of claim 18, wherein the optical system comprises a Mirau type interferometer, a Michelson type interferometer, or a Mach Zender type interferometer.

34. The detecting method as claim 18, wherein the optical system comprises a Mirau type interferometer comprising an interference means with a selective coating reflecting a reference arm to interfere with a sample arm backscattered from the sample, and at least two split lights processed into the objective onto the sample wherein the lights off axis of center of the objective illuminating on the sample through the objective are unblocked by the selective coating disposed on the interference means.
